(19) United States
(12) Patent Application Publication
(10) Pub. No.: US 2008/0010033 A1
(43) Pub. Date: Jan. 10, 2008

(54) Measurement correction device and method

(76) Inventor: Michael Ian Gitter, New York, NY (US)

Correspondence Address: WILLIAM B. GOWANLOCK, 16 TOWN CRIER LANE, MADISON, CT, 06443, US

(21) Appl. No.: 11/481,315

(22) Filed: Jul. 5, 2006

(51) Int. Cl. G06F 19/00

(52) U.S. Cl. 702/81; 702/1; 702/85; 702/101; 702/127

(57) ABSTRACT

A measurement correction device and method for its use. The measurement correction device is used to detect a change in scale resulting from its replication wherein the replication is made without attention to the scale. In one exemplary application, the measurement correction device is used in conjunction with a measurement scale to detect changes in scale of the measurement scale resulting from the replication of the measurement scale.

### FIELD OF THE INVENTION

The present invention relates to measurement of an object and more specifically to correcting a measurement made of the object by a replica of a measurement device, i.e., a replicated measurement device, wherein the replicated measurement device is at an uncertain scale as to the measurement device from which is was replicated.

### BACKGROUND

The Internet has spawned numerous businesses. Many of the businesses are retailers of sized items, such as clothing and shoes. In the sale of a sized item, the purchaser, in addition to selecting the desired item, must specify the size of the item. If an order is placed for an item, but the size is not properly determined, the item in all likelihood will be returned to the retailer. A returned item increases a retailer's costs, thus reduces a retailer's profits.

The selection of a proper size of a sized item by a purchaser is no simple task. For example, for a purchaser purchasing a dress, the purchaser must acquire several measurements, such as bust, waist and hips, and then convert those measurements into a single standard size equivalent. In other cases, actual measurements are used. For example, a men's shirt is generally sold by neck and sleeve length. In any case, the purchaser must obtain the necessary measurements for the sized item to make the proper size determination.

To make any measurement, a measurement device, such as a ruler, must be used. In the case of a sized item, the necessary measurement device could be a simple tape measure, or a measurement device specifically designed for the item, such as a Brannock Foot Measurement Device that equates the dimensions of a foot to a shoe size. In any case, where the retailer relies on the purchaser to provide the measurement device, this places an additional burden on the purchaser. This additional burden may result in a lost sale if the measurement device is not available or, if the purchaser employs a less than optimum measurement device, e.g., a rigid ruler in place of a flexible one, a high probability that an incorrect size will be ordered.

If the retailer wishes to provide the measurement device to a potential purchaser, the retailer faces the daunting challenge of transmitting the measurement device over the Internet. The transmission of a measurement device over the Internet requires that the retailer convert the measurement device into an electronic form, e.g., a file, and transmit that electronic form to the user. Upon receipt of the electronic form by the user, the user has to convert the electronic form into a usable measurement device. In all likelihood, to use the electronic form of the provided measurement device the user will create a replicated measurement device by printing out the electronic form using a printer.

The Internet has numerous users collectively using a hodgepodge of computers and printers. Thus, while the retailer can carefully control the selection, or creation, of a measurement device and conversion of the measurement device into an electronic form, the retailer has no control over the replication of the measurement device by a purchaser. Thus, the measurement device may change scale from its selection, or creation, by the retailer to replication by a purchaser. If a change in scale occurs and the replicated measurement device is used by a purchaser to determine the proper size, the size determined by the replicated measurement device will be incorrect, unless the purchaser can identify the change in scale to the retailer when the order is placed.

The identification of a change in scale, while fundamentally easy to appreciate, is much more difficult to quantify. If the retailer places the burden on the purchaser to determine the change in scale, the retailer must rely on the purchaser to obtain a customary measurement device, then measure some aspect of the replicated measurement device and provide those measurements to the retailer. In some cases though, the replicated measurement device may not lend itself to easy scale analysis using customary measurement devices to which a typical purchaser has easy access.

In the alternative, the retailer may desire to have the purchaser measure a standard (i.e., something that has a size determined by documented standard such as a credit card) known to the retailer using the replicated measurement device. This assumes that the replicated measurement device is capable of measuring a standard that is readily available to the purchaser.

In both of these situations, the issue is further complicated if multiple measurement devices are required.

What is needed in the art is an apparatus and method that is independent of a measurement device that allows a purchaser to identify readily to a retailer a change in the scale of replicated measurement device provide to them by the retailer.

### SUMMARY OF THE INVENTION

This invention is a measurement correction device and a method for its use within a measurement system. The measurement correction device makes use of a standard to make an implication about any scale change to a measurement device with which it is associated resulting from an unknown replication of the measurement device.

These and other features, aspects, and advantages of embodiments of the present invention will become apparent with reference to the following description in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 is a drawing of a measurement correction device.

FIG. 2 is a flow diagram for using the measurement correction device.

FIG. 3 is several foot measurement devices used in conjunction with a measurement correction device.

FIG. 4 is a drawing of a second embodiment of the measurement correction device.

FIG. 5 is a drawing of a third embodiment of the measurement correction device.

FIG. 6 is a drawing of a fourth embodiment of the measurement correction device.

### DETAILED DESCRIPTION

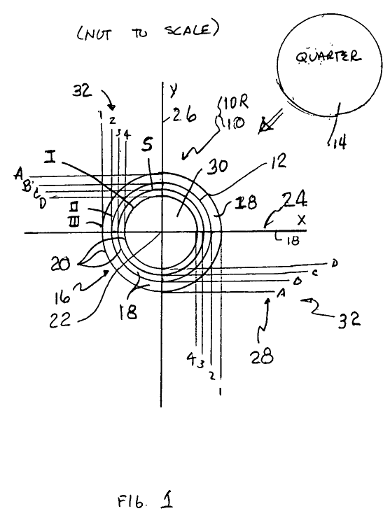

As shown in FIG. 1, a measurement correction device (generally referred to by reference number 10) includes a standard position 12 (labeled “S”), based on a known standard 14, associated with a measurement scale 16. The standard 14 is an object that has a shape, thus dimensions, controlled by a recognized standard, such as an International Organization for Standardization (ISO) standard or similar. Typical standards 14 include coinage and credit cards. Additionally, to facilitate ease of use of the measurement correction device 10 by the public, the standard 14 should be in broad distribution to the public. In this embodiment, the illustrated standard 14 is a quarter, but other circular as well as non-circular standards could be used.

As the illustrated standard 14 is a quarter, the standard position 14 is a circle having a perimeter at a diameter equal to the known diameter of a quarter that defines an area 18. The standard 14 when placed on the measurement correction device 10 coincides with the area 18 of the standard position 12.

As explained below, the measurement correction device 10 may be used in a measurement system wherein it is replicated; thereby creating a replicated measurement correction device 10R. The replicated measurement correction device 10R is identical to the measurement correction device 10, except that it may be at any scale to the measurement correction device, such as 95%, 100%, or 105%. As a result for discussion purposes, FIG. 1 is equally applicable as to the measurement correction device 10 and to the replicated measurement correction device 10R.

The measurement scale 16 measures enlargements and reductions of the replicated measurement correction device 10R. In this embodiment, the measurement scale 16 includes a series of gradations 20 that are circular (Labeled I, II, and III), each having an area 18. Ideally, these gradations 20 represent enlargements and reductions from the standard position 12 at known intervals, such as 2% or 5%.

The number of and interval between gradations 20 are based on the anticipated amount of enlargement or reduction of the replicated measurement correction device 10R, and the degree of precision required in knowing that enlargement or reduction, thus are application dependent. The smaller the intervals between gradations 20 the greater is the accuracy, while the greater the number of gradations 20 for any given interval size, the greater the range.

It should be appreciated, that gradations 20 that are larger than the standard position 14 are used to determine when the replicated measurement correction device 10R is a reduction as to the measurement correction device 10, while gradations 20 smaller than the standard position 12, are used to determine when the replicated measurement correction device 10R is an enlargement as to the measurement correction device 10.

The measurement correction device 10 may incorporate a point 22 about which the standard position 12 and the gradations 20 are concentric. It should be appreciate, that in this type of configuration the areas 18 will overlap. The point 22 may also define the intersection of an x-axis 24 and a y-axis 26 of a standard coordinate system.

The measurement correction device 10 may also incorporate a placement grid (generally referred to by reference number 26). The placement grid 28 assists a user of the measurement correction device 10 in proper placement of the standard 14 thereon. The illustrated placement grid 28 utilizes cooperating, symmetrical parallel lines. In this case, the placement grid 28 has two sets of parallel lines with one set being perpendicular to the other.

The measurement correction device 10 may also incorporate various colors. The colors may be used to distinguish between the standard position 12 and various gradations 20, as well as between various gradations. For example, red could be used in the area 18 of the standard position 12, blue in the area of the next larger gradation 20, and yet another color in the area of the next smaller gradation. It should be appreciated that since in this embodiment the areas 18 overlap, the colors will be placed one over the other creating something of a target effect. In addition, colors could be reused, but it would be preferred that in the event the same colors are used they are not placed in adjacent areas.

In this embodiment, the placement grid 28 is coincidental with the measurement scale 16. The placement grid 28 may be labeled along the x-axis 24 with 1, 2, 3, etc. and along the y-axis 26 with A, B, C, etc. In effect, the labeling acts as a second scale 32, which gives another method for reporting how the standard 14 is located on the replicated measurement correction device 10R. This will be explained in greater detail below.

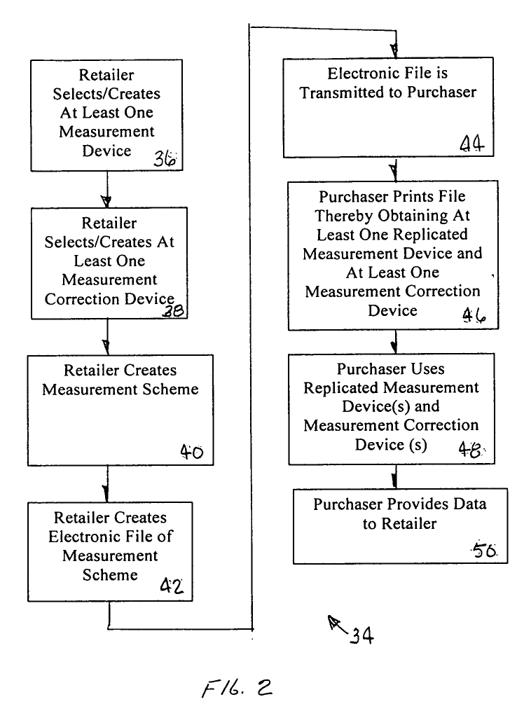

Referring to FIG. 2 and as discussed above, the measurement correction device 10 may be used in a measurement system (generally referred to by reference number 34). In such a measurement system 34, the measurement correction device 10 may be used in conjunction with a measurement device wherein a step in the measurement system 34 may require the uncontrolled replication of the measurement device. Uncontrolled replication means that the measurement device has an original scale, but it is replicated without attention to maintaining that scale. Thus, a user who makes the replication is unaware of any scale relationship of the replicated version to the original, even if 100%.

In this exemplary measurement system 34, the measurement correction device 10 is used by an on-line retailer selling sized goods wherein the retailer wishes to provide a measurement device to a prospective purchaser to assist the purchaser in determining the proper size of the goods to order. While the measurement system 34 is presented in a series of sequential steps in a particular order, this particular presentation should not be considered as a limitation. The steps may occur in any order as long as output and input limitations of the steps are observed. In other words, if one step requires something created in another step, the other step must come first.

As indicated in step 36, the retailer selects at least one measurement device for use by a purchaser in making measurements relevant to determining the size of a good the retailer desires to sell to a purchaser. The measurement device(s) can be of any type, such as ruler or gird.

In step 38, the retailer creates or identifies at least one measurement correction device.

As shown in step 40, the retailer associates the at least one measurement device with the at least one measurement correction device to create a measurement scheme. It should be appreciated that the retailer could create a measurement scheme having multiple measurement devices associated with multiple measurement correction devices. In the alternative, as the use of the measurement correction device is independent from the use of the measurement device(s), it should be appreciated that the measurement scheme might include one measurement correction device and multiple measurement devices.

Continuing with step 42, the retailer then creates an electronic form of the measurement scheme. An electronic form can be created by any conventional means, such as by scanning or electronic creation.

As stated in step 44, the electronic form is then transmitted to the purchaser. The precise method of transmission is application dependent, but could include transmission over a computerized network (e.g., the Internet) or by hard media (e.g., computer disc or CD).

Continuing on with step 46, the purchaser converts the electronic form of the measurement scheme into a usable form (e.g., a physical form such as a printout), thereby replicating the at least one measurement device and the at least one measurement correction device. Since the electronic form has been converted to a usable form by the same computer system (e.g., hardware, software and printer), the replicated measurement device and the replicated measurement correction device should be in the same scale one to the other.

This outcome can be assured if the electronic form is in a Portable Document Format file, more commonly referred to as a PDF file. A PDF file is used to represent a dimensional document, and is device independent and resolution independent. This means that the dimensional relationships of the contents of a PDF file, e.g., the at least one measurement correction device and the at least one measurement correction device, will not be altered one to the other in a replicated form.

Continuing with step 48, after the purchaser obtains the usable version of at least one replicated measurement device and the at least one replicated measurement correction device, the purchaser uses the at least one replicated measurement device to obtain the necessary size information. Additionally, the purchaser obtains the necessary standard(s) and takes a reading from the at least one replicated measurement correction device. It must be remembered that the purchaser is unaware of any change in scale that may exist between the retailer's at least one measurement correction device and at least one measurement device, and the purchaser's at least one replicated measurement correction device and at least one measurement device.

In the next step 50, the purchaser submits the measurement(s) and reading(s) to the retailer. Using these inputs, the retailer then determines the proper size of item to sell and to ship to the purchaser. The retailer determines the proper size by correcting the provided measurements based on the reading submitted for the measurement correction device. This is a straight-forward computation of scale, based on the retailer's knowledge of the standard and the at least one measurement correction device, easily accomplished by those having mathematical skills.

As discussed above, the purchaser must take a reading of a standard on the replicated measurement correction device. Referring to FIG. 1, and assuming that this is now the replicated measurement correction device 10R, the purchaser takes this reading as follows. The purchaser obtains the standard 14, which in this case is a quarter. The purchaser then places the quarter on the replicated measurement correction device 10R. The purchaser aligns the quarter such that the purchaser can identify the minimum area into which the quarter will fit. For example, if the replicated measurement correction device 10R was reduced when compared to the measurement correction device when replicated, the quarter will cover the standard position 12 labeled “S,” but fit within a gradation 20 that is larger in size, for example the gradation labeled “I.”.

If the measurement correction device 10 employs colors in the areas 24, the purchaser could merely determine the color that is observable around the standard 14. For example, if the standard position 12 were red and the next larger gradation 18 were blue, the purchaser could report that blue was visable.

Where a placement grid 28 is present, the purchaser may use the placement grid to locate more precisely the standard 14 on the replicated measurement correction device 10R. In the case of the placement grid 14 illustrated, the purchaser would place the quarter on the replicated measurement correction device 10R such that two opposing edges of the standard 14 are proximate the same opposing x-axis locations and two other opposing edges are proximate the same opposing y-axis locations. Centering the standard 14 using the placement grid 14 assures a more accurate determination of the scale.

In the event a second scale 32 is present, the purchaser might read the scale. For example, if both the measurement correction device 10 and the replicated measurement correction device 10R were to the same scale (e.g., 100%), the quarter would have two opposing edges aligned with opposing “2s” on the x-axis 24 and another two opposing edges aligned with opposing “Bs” on the y-axis 26. It should be appreciated that in this case, the replicated measurement correction device 10R was at 100% and the scaling was equal along the x-axis 24 and the y-axis 26.

It should be appreciated that neither of these conditions is a requirement. For example, in the event the replicated measurement correction device 10R is not uniformly scaled along the x-axis 24 and y-axis 26 when replicated, the standard 14 could have opposing edges on the “Bs” and the other opposing edges on the “3s.” It should be readily appreciated that if this were the case, the standard position 14 and any gradations 20 in all likelihood would not appear circular.

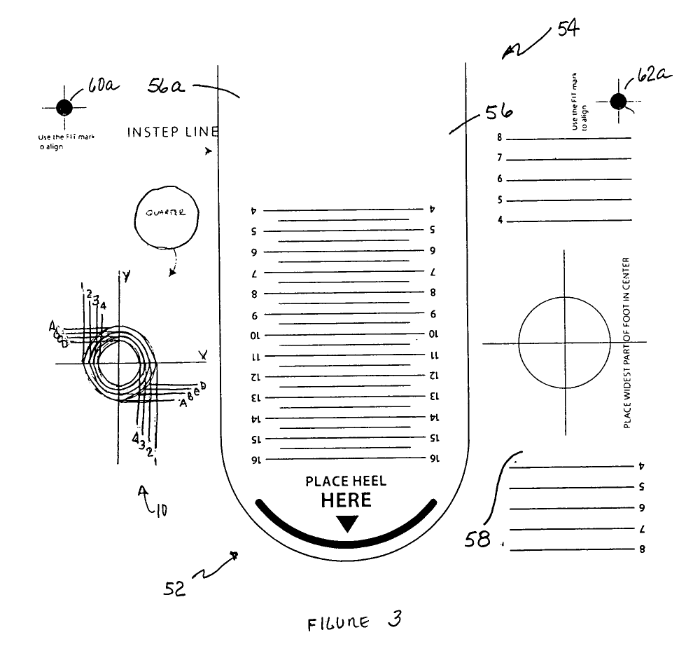

The measurement correction device 10 may be used in a measurement scheme. As discussed, a measurement scheme is created when a measurement correction device 10 is used in conjunction with a measurement device. One such measurement scheme (generally referred to by reference number 52) for determining the size of a foot is shown in FIG. 3 (which is greatly reduced to fit in the allotted area). This exemplary measurement scheme 52 has a measurement correction device 10 and a foot measurement device 54.

The foot measurement device 54 has a length measurement scale 56, which includes a first part 56a and a second part 56b, and a width measurement scale 58. As depicted, the foot measurement device 54 was created over two pages from a PDF file. The two pages are registered one to the other using a pair of registers 60a and 60b, and 62a and 62b. In use, a person connects the two parts 56a, 56b of the foot measurement device 56 using the registers 60a, 60b, and 62a, 62b. It should be appreciated that this example, shows a single replicated measurement correction device being used to correct a measurement device that spans two pages.

To obtain a foot measurement, a person properly places a foot (not shown) on the foot measurement device 54 to obtain a length measurement and a width measurement. The person would then use a quarter (note the replicated measurement correction device 10R is the one presented above), to obtain a reading on the replicated measurement correction device 10R. The person would then report all measurements and the reading to the retailer. Based on the measurements provided, the retailer would be able to correct the provided measurements to obtain the actual length and width measurements for each foot so the correct size shoes could be provided.

It should be appreciated that in this exemplary case, the measurement scheme has a single measurement correction device 10 being used to correct measurements made by two different measurement scales, the length measurement scale 56 and the width measurement scale 58. Additionally, it should be appreciated that the two measurement scales 56, 58 are oriented one to the other such that one, the length measurement scale 56, is oriented along the y-axis 26 of the measurement correction device 10, and the width measurement scale 58 is oriented along the x-axis 24 of the measurement correction device. Thus, the multiple axis capability of this particular measurement correction device 10 allows for any deviation in scaling between the x- and y-axis 24, 26 to be determined and taken into account.

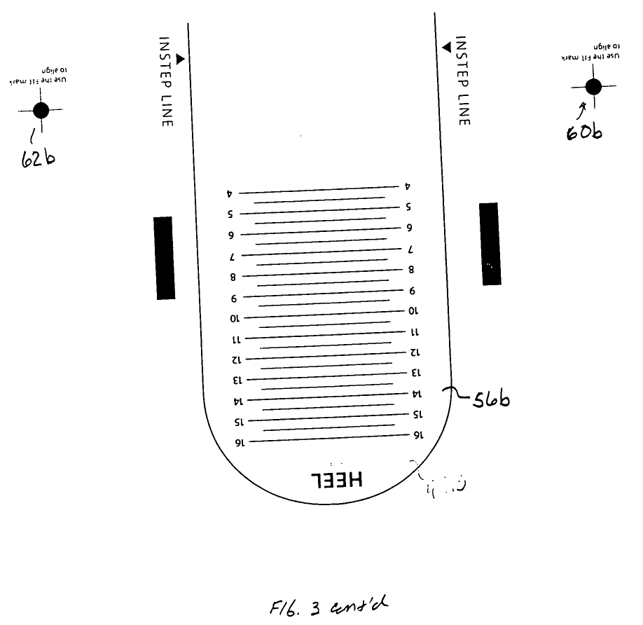

FIG. 4 shows a second embodiment of the measurement correction device 210 (similar features to the basic invention use the same reference number preceded by a “2”). This embodiment depicts a linear arrangement of the standard position 212 with corresponding measurement scale 216 with gradations 220. This embodiment is illustrated for use with a standard 214 (not shown) that is round, such as a coin. As with the previous embodiment, colors may be used. In this case, colors may be used within the areas 228 defining the standard position 212 and the various gradations 220.

This measurement correction device 210 could be used in several ways. One way to use this measurement correction device 210 is to have a user find the smallest area 64, standard location 212, or gradation 220, the standard 214 is completely within.

This embodiment further may include a placement grid 228. The illustrated placement grid 228 is in the shape of a triangle and the various locations, standard position 212 and gradations 220, have been placed such that the placement grid 228 intersects the various areas 228 at tangent points. Additionally, a second scale 232, which is separate from the placement grid 228, is positioned along an axis of the measurement correction device 210. In this case, the second scale 232 is positioned along the longitudinal axis.

A purchaser uses a replicated version of this measurement correction device 210R, which incorporates a placement grid 228 and second scale 232, by placing a quarter on the measurement correction device and moving it until opposing edges of the quarter coincided with the two sides of the placement grid. The purchaser would then report the location of the standard 214 using the second scale 232 and/or gradations 220.

It should be appreciated that this embodiment will only determine expansion or reduction of the replicated measurement correction device 210R in one axis. Therefore, if the measurement device with which it is associated incorporates multiple axes of measurement, the measurement correction device 10 should have separate measurement correction device 210 for each axis of measurement.

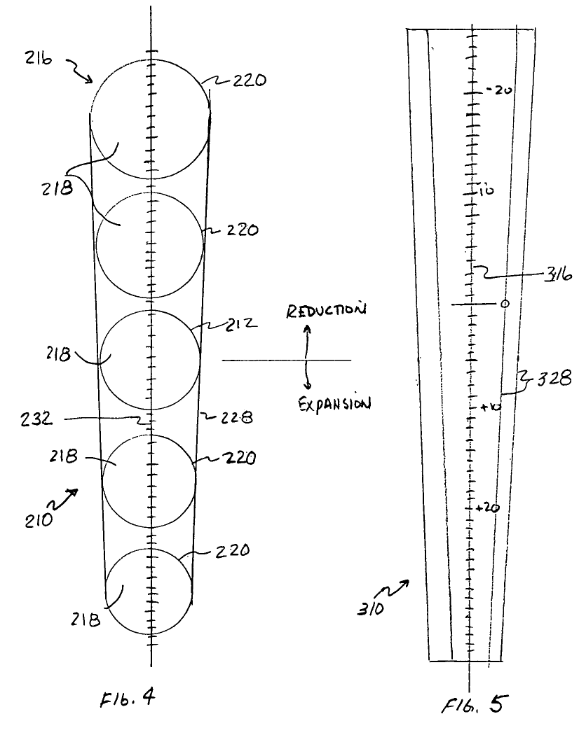

FIG. 5 shows a third embodiment of the measurement correction device 310 (similar features to the basic invention use the same reference number preceded by a “3”). This embodiment is designed for use with more than one standard 314. More specifically, this embodiment is designed for similar multiple standards having different sizes, such as a quarter and a nickel.

The measurement correction device 310 has a measurement scale 316 that incorporates a pair of placement grids 328. In this exemplary embodiment, one placement grid uses a quarter as the standard 314 and the other placement grid uses a nickel as a standard 314. Since a nickel has a diameter that is smaller than a quarter, the placement gird 328 for the nickel is the one closer to the measurement scale 316. Both a quarter and nickel when properly placed on the measurement correction device 310 will have an edge on a common point, in this case “0.”

In use, a person selects the most convenient standard 314 (not shown), then places the standard 314 on the replicated measurement correction device 310R and moves the standard until the outer edges simultaneously contact that appropriate placement grid 328. The person then reads off the scale where an edge, e.g., upper or lower, contacts the scale. The person then reports the standard 314 used, the reading, and the edge from which the reading was taken.

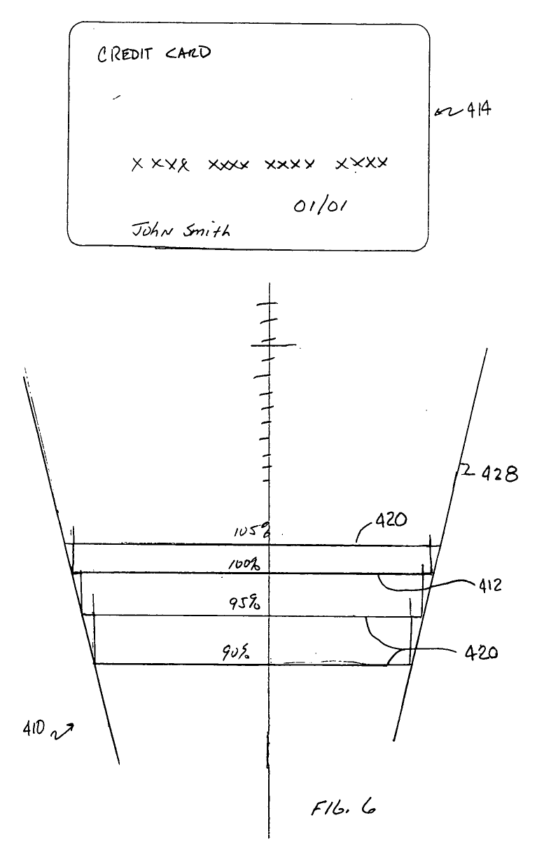

FIG. 6 shows a fourth embodiment of the measurement correction device 410 (similar features to the basic invention use the same reference number preceded by a “4”). This embodiment is quite similar to the third embodiment, but it uses a rectangular shaped standard 414, such as a credit card. For reference, the shape of a credit card is shown in FIG. 4. It should be noted that while a credit card has a generally rectangular shape, the corners are rounded.

The measurement correction device 410 has a standard position 412 and gradations 420. The gradations 420, however, are on one complete edge and portions of the two perpendicular edges extending therefrom. The perpendicular edges, while not required, are helpful since, as discussed above, a credit card does not have square corners.

While there has been illustrated and described what is at present considered to be preferred and alternative embodiments of the claimed invention, it will be appreciated that numerous changes and modifications are likely to occur to those skilled in the art. It is intended in the appended claims to cover all those changes and modifications that fall within the spirit and scope of the claimed invention.

What is claimed is:

1. A measurement system comprising the steps of:
obtaining at least one measurement scale;
obtaining at least one measurement correction device, the at least one measurement correction device employing a standard;
associating the at least one measurement scale with the at least one measurement correction device thereby creating a measurement scheme; and
creating an electronic file of the measurement scheme.

2. The measurement system of claim 1 further including the steps of:
replicating the measurement scheme without attention to scale to obtain a usable at least one replicated measurement scale and at least one replicated measurement correction device;
making measurements using the at least one replicated measurement scale;
taking a reading from the at least one replicated measurement correction device; and
correcting the measurements based on the reading.

3. The measurement system of claim 1 including the additional step of transmitting the electronic file over a network.

4. The measurement system of claim 3 wherein the step of transmitting the electronic file occurs before the step of creating a replicated measurement scale and a replicated measurement correction device.

5. The measurement system of claim 1 wherein the step of obtaining at least one measurement scale includes a measurement scale for measuring the dimensions of a foot.

6. The measurement system of claim 1 wherein in the step of obtaining at least one measurement scale, more than one measurement scale is obtained.

7. The measurement system of claim 1 wherein in the step of obtaining at least one measurement correction device, more than one measurement correction device is obtained.

8. The measurement system of claim 1 wherein in the step of obtaining at least one measurement correction device, the standard is a coin.

9. The measurement system of claim 1 wherein in the step of obtaining at least one measurement correction device, at least one of the at least one measurement correction device is suitable for use with more than one standard.

10. The measurement system of claim 1 wherein in the step of obtaining at least one measurement correction device, the standard is a credit card.

11. The measurement system of claim 1 wherein in the step of obtaining at least one measurement correction device, at least one of the at least one measurement correction device detects scaling in both x and y directions.

12. A measurement correction device for determining scaling resulting from replication comprising:
a standard position having a size commensurate with a standard when the measurement correction device is at a scale of 100%; and
a measurement scale having a defined scaled relationship with the standard position and associated therewith,
whereby a scale change in the measurement correction device when replicated can be measured.

13. The measurement correction device of claim 12 further including another measurement scale for use with another standard and having a common element with the measurement scale.

14. The measurement correction device of claim 13 wherein the second standard position and the standard position have a common reference on the measurement scale.

15. The measurement correction device of claim 12 wherein the standard is a coin.

16. The measurement correction device of claim 12 wherein the standard is a credit card.

17. The measurement correction device of claim 12 wherein the standard position and the plurality of gradations are concentric.

18. A measurement scheme comprising:
at least one measurement device, and
at least one measurement correction device.

19. The measurement scheme of claim 18 wherein the number of measurement devices exceeds the number of measurement correction devices.

20. The measurement scheme of claim 18 wherein the at least one measurement correction device employs a standard.

21. The measurement scheme of claim 18 wherein the at least one measurement device and the at least one measurement correction device are contained together in an electronic file.
